(19) United States
(12) Patent Application Publication
(10) Pub. No.: US 2019/0090519 A1
(43) Pub. Date: Mar. 28, 2019

(54) FERMENTED FLOUR NUTRACEUTICAL TORTILLA AND PROCESS FOR PREPARATION THEREOF

(71) Applicant: UNIVERSIDAD NACIONAL AUTONOMA DE MEXICO, MEXICO CITY (MX)

(72) Inventors: Raquel Gómez Pliego, Cuautitlan lzcalli (MX); Yolanda Marina Vargas Rodriguez, Tlalnepantla de Baz (MX); Guadalupe lveth Vargas Rodriguez, Melchor Ocampo (MX); Norma Guerrero Olvera, Cuautitlan lzcalli (MX)

(21) Appl. No.: 16/144,132

(22) Filed: Sep. 27, 2018

(30) Foreign Application Priority Data
Sep. 27, 2017 (MX) MX/A/2017/012376

(51) Int. Cl. A23L 7/104; A21D 13/42; A23L 33/135; A23L 33/19; A23L 33/00

(52) U.S. Cl. CPC A23L 7/104; A21D 13/42; A23L 33/135; A23L 33/19; A23V 2250/7056; A23V 2200/3204; A23V 2250/1578; A23V 2250/5424; A23L 33/30

(57) ABSTRACT

A process for manufacturing a nutraceutical tortilla prepared from wheat flour as an alternative for malnutrition and obesity, wherein two fermentations are carried out with probiotic microorganisms, lactic bacteria (Streptococcus thermophilus, Lactobacillus bulgaricus, Lactobacillus plantarum) and with Saccharomyces cerevisiae yeast and enriched with prebiotics (inulin), milk protein, calcium and folic acid, resulting in a high nutritional value product and with probiotic microorganisms, resulting in a tortilla that does not need preservative added during manufacturing thereof.

### FIELD OF THE INVENTION

The present invention is related to techniques used in food industry, and more particularly is related to a process for obtaining a nutraceutical tortilla prepared from wheat flour where fermentations with probiotic microorganisms, lactic bacteria and with prebiotic-added yeasts are carried out and enriched with milk protein, calcium and folic acid, given a high nutritional value product as result.

### BACKGROUND OF THE INVENTION

Origin of tortilla in Mesoamerica is as far back as 500 B.C. For example, in Oaxaca region there are evidences that tortilla started to be used at the end of Villas Age (1500 a 500 B.C.), which is known because clay plates used for cooking appeared from that time. The pre-Columbian civilizations of Mesoamerica used corn as their food base as well as modern society in this same region. Evidences have been found to locate the first corn crop date back to 7000 B.C. and the preparation and intake of tortilla has from a similar time. Currently the tortilla is prepared by a nixtamalization process (corn cooked with lime).

Corn tortilla is one of the most ancient symbols in Mexican culinary culture. Nowadays, tortilla is daily consumed by more than 90% of Mexican people, being an important part for their nutrition.

Tortilla provides energy due to its high carbohydrate content, further being rich in calcium, potassium and phosphorous. It also provides fiber, proteins and some vitamins such as vitamin A, thiamin, riboflavin and niacin.

Two main public health issues derived from poor nutrition are currently present in Mexico, when poor nutrition is excessive it derives into obesity and overweight and when being deficient, malnutrition problems are present.

Obesity is one of the leading and largest public health problems affecting not only adults but also children. Mexico shows a first place in childhood obesity around the world and the second in obesity in adults according to the Organization for Economic Cooperation and Development (OECD, 2014, Hernández-Avila et al., 2013). Prevalence of overweight and obesity has reached alarming rates in Mexico. In 2012, 73% of adult women, 69% of adult men and more than 30% of children and teenagers had overweight or obesity (National Institute of Public Health, 2012; Barquera et al., 2013).

In this context, prevalence of overweight and obesity in Mexican teenagers from 12 to 19 years old has shown a remarkable increase, which moved from 31.2% in men and 34.2% in women in 2006, to 34.1% in men and 35.8% in women. [National Health and Nutrition Survey (ENSANUT 2012)].

Although the epidemic of obesity is caused by multiple and complex factors, the diet is definitely a key factor as well as the consumption of sugary drinks and lack of exercise (Malik et al., 2006; Vartanian et al., 2007).

Due to so-accelerated new lifestyles of population, consumption of foods from fast and easy preparation has considerably increased in recent years, prevailing an increased intake of high-caloric foods that are rich in fat, salt and sugars, but poor in protein, fiber, vitamins, minerals and other micronutrients causing overweight, obesity or malnutrition problems.

Malnutrition is one of the diseases that affect the country. The acute malnutrition, defined as one that has a lower weight for the size or low height-for-age (Rivera et al., 2013). It is defined as conditions which occur when the body does not receive or absorb sufficient nutriments. According to the National Health and Nutrition Survey conducted in 2012, 2.8% of children younger than five years old in all Mexico showed low weight, 13.6% of them show low height and 1.6% acute malnutrition.

Despite the enormous efforts that Mexican Government in general has made in recent years to mitigate the impacts caused by these two pathologies (malnutrition, which affects in a significant way to the country's Southern region, and obesity, which makes it in the Northern region and eventually spread throughout the Mexican territory), those efforts have not been enough and still much has to be done since they remain a problem to solve in the country with economic, social and health implications in the short, medium and long term. Therefore, it is important to apply nutrition education strategies to promote healthy ways of life, such as having healthy and balanced diets, exercise in open air, decrease in the consumption of sugary drinks and the like, in all age groups, with special emphasis on children and adolescents, whose feeding depends on their parents' surveillance.

Within the food recommended for good health are those known as functional or nutraceutical, which have been scientifically proven to have a beneficial effect in one or several body's functions; then they provide a better state of health and well-being in people who ingest them. In order to provide an alternative solution to the problems arising from these two pathologies, a tortilla fermented with probiotics, by lactic bacteria (Streptococcus thermophilus, Lactobacillus bulgaricus, Lactobacillus plantarum) and by Saccharomyces cerevisiae yeast, enriched with inulin (insoluble fiber) and fortified with whey solids, calcium, folic acid, monounsaturated fatty acids (olive oil) and preservative-free was formulated and developed in this work. It is important to highlight that in Mexican and international markets there are no tortillas with similar or equal characteristics than those developed in this invention, there are neither patents nor bibliographic references that indicate that this product has been developed or previously developed. Nowadays, the food industry has focused on the study and the creation of new food products that in addition to nurture, provide substances that improve health or prevent the risk of some diseases to consumers, what is known as functional food (Illanes, 2015).

There are several types of tortillas and methods for preparation thereof within the state of the art, and also several publications related to such food, which include the European publication EP2044843 related to a method of preparation of a flour tortilla comprising: providing a flour tortilla dough in a portion sufficient to prepare the tortilla; applying a fatty substance to at least part of the dough surface, then forming the dough in a tortilla shape and after that, baking the dough. The invention further refers to a tortilla obtained by means of such method and to the use of a fatty substance to improve a property of a tortilla prepared using a fatty substance.

US2017172160 patent application intends protection for a tortilla and a tortilla product formed by a process including scraping at least one dough layer from the dough shape used for preparing the tortilla, and a fried tortilla product formed by use thereof. The process produces a fried product that exhibits an unexpectedly different surface profile and texture, as well as improved flavor.

On the other hand, Mexican document MX2015017410 discloses an invention related to a nutraceutical dough obtained from a mixture of varieties of native maize (Chalqueño, VC-42 blue (Bolita), Cone red), theirs uses and method of production thereof. Typical uses of the dough include formulation of a nutraceutical blue tortilla from mixtures of native blue/purple kernel corn varieties and inclusion of a functional ingredient also obtained from a maize native variety. The tortilla of the invention is characterized in that comprises two times more antioxidants than a traditional tortilla, without affecting their sensory or nutritional qualities. Nutraceutical blue tortilla provides an option to substantially increase the antioxidant intake among Mexican population using a popular consumption product. A second use of the nutraceutical dough obtained from the mixture of native maize varieties (Chalqueño, VC-42 blue (Bolita), Cone red) consisting of producing corn-base fried snacks frying the dough under the traditional way at high temperatures in oil or butter to brown afternoon snacks, which composition includes natural maize color together with its nutraceutical properties.

Also, the Universidad Veracruzana applied for a patent file number MX2013011202 related to the use of blue corn tortillas as nutraceutical food, which anti-cancer properties are present in cell lines at a dose of 100 g that have inhibited the growth of K-562 leukemia cell line by 97.4%, MCF-7 breast cancer cells by 67.5%, HCT-15 colon cancer cells by 58.3%, SKLU-1 lung cancer cells by 48.3% and prostate cancer cells by 46.8%.

On the other hand, WO2013129951 international application discloses a tortilla and a method for producing tortillas, the tortilla being round and flat with a diameter from 6 to 30 cm made of wheat or corn flour, used as bread and as basis for other foods. The tortilla according to the invention is formed from wheat flour, water and fat. The tortilla is characterized in that comprises 61-64% wheat flour, 23-26% water, 4-6% palm oil, 2-4% glycerin, 0.5-0.8% disodium diphosphate, 0.3-0.6% of 1.1-1.4% salt, 0.8-1.2% glucose, 0.13-0.22% citric acid, 0.13-0.22% xanthan gum, 0.04-0.13% enzyme preparation, 0.48-0.57% fatty acid mono- and diglycerides and 0.2-0.4% malic acid, 0.2-0.4% guar gum, 0-0.01% L-cysteine. A method to produce tortillas, in accordance with the invention, consists of dispensing the ingredients into the mixing bowl, mix dry ingredients followed by the addition of water, and mixing them and the obtained mass is divided into balls, which undergo maturation and once matured, pressed to the required thickness using a press with a suitable temperature, after which they are baked and then cooled. The method is characterized in that the obtained tortilla is subject to an additional specific cooking at a temperature of 300-500° C. during 10 seconds, after which the tortilla is cooled in a cooling tunnel at a temperature of 10-15° C. and 50-75% relative humidity during 0.5-2 min.

Mexican patent application MX2010002881 discloses composed tortilla dough made with corn and powder-dehydrated prickly cactus flour which increase calcium and fiber content in final product. The tortillas show a much extended storage life than prior art products and are suitable for human consumption.

Moreover, Mexican document MX2011007829 discloses a fortified tortilla comprising soybean paste, stabilizers and/or nixtamalized corn flour and/or fresh dough for tortillas and/or water. The invention also refers to a procedure for obtaining such fortified tortilla from dry soybean paste comprising weighing the dry soybean dough, pouring drinking water into the dough, adding hot water and sodium bicarbonate. Soybean dough is continuously stirred and then drained with a metal strainer. Soybean dough is ground in a stone grinder to obtain treated soybean dough that is mixed with flour and nixtamalized stabilizers or with fresh tortilla dough to obtain fortified dough. Said dough is cooked in a metal sheet or plate, supplying the fortified dough to a mechanical tortilla machine to obtain cooked tortillas continuously over rotary sheets heated by gas.

U.S. Pat. No. 4,735,811 claimed an improved tortilla that has a shelf life increased while maintaining improved flexibility during the useful life. The tortilla is composed of flour, water and other plasticizing agents to provide a low moisture content product that still has a high liquid content. The tortilla is cooked to fully gelatinize the starch inside the tortilla. The tortilla is cooled, packaged and stored having a storage life of about ninety days, keeping sufficient flexibility at the same time to prevent noticeable cracks when folded for use.

In the light of the above, it has been intended to suppress the inconveniences shown by tortillas and preparation processes thereof known in the prior art, by proposing a nutraceutical tortilla prepared from wheat flour where fermentations with probiotic microorganisms, lactic bacteria and with prebiotic-added yeasts and enriched with milk protein, calcium and folic acid are carried out, resulting in a high nutritional value product.

As noticed from the state of the art, a wheat flour tortilla has not been disclosed where fermentations are carried out with probiotic microorganisms used in the present invention which further withstand cooking and with tortillas that are kept for consumption for up to one month after manufacturing. Another novelty of the present invention is that the organic compounds produced during the fermentation process (lactic acid, acetic acid, bacteriocins, diacetyl, acetaldehyde, etc.) confer a high shelf life therefore, they may have a storage time for up to 40 days without refrigeration and 90 days kept under refrigeration without addition of preservatives. They also provide good taste, scent, and texture and by further adding fiber (inulin) and probiotic bacteria they confer a beneficial effect for health of malnourished and obese persons. Another quality is that the possessed energetic value is due to added nutrients (free of empty calories) such as milk protein, and whey solids rich in proteins, calcium, folic acid, unsaturated fatty acids and nutrients contained in added bacteria and yeasts.

As shown from that above, there are currently technical issues and drawbacks in respect of boluses from the state of the art.

As a result from the facts above, it has been intended to suppress the existing problems in prior art, which has led to develop the present invention which is described below.

### OBJECTS OF THE INVENTION

Taking into account the deficiencies from prior art, it is an object of the present invention to provide fermented and fortified wheat flour tortillas as an alternative for malnutrition and obesity.

A further object of the present invention is to provide a nutraceutical tortilla prepared from wheat flour wherein two fermentations with probiotic microorganisms, lactic bacteria (Streptococcus thermophilus, Lactobacillus bulgaricus, Lactobacillus plantarum) and with Saccharomyces cerevisiae yeast are carried out

Another further object of the present invention is to provide a nutraceutical tortilla prepared from wheat flour where fermentations with probiotic microorganisms which also resist cooking are carried out.

It is another object of the present invention, to provide a nutraceutical tortilla added with prebiotics (inulin) and enriched with milk protein, calcium and folic acid, resulting in a high nutritional value product and with probiotic microorganisms.

A further object of the present invention is to provide a process to prepare a nutraceutical tortilla including 2 fermentation steps, a yeast-produced alcoholic fermentation (Saccharomyces cerevisiae) and a lactic fermentation produced by lactic bacteria (Streptococcus thermophilus, Lactobacillus bulgaricus, Lactobacillus plantarum).

Another further object of the present invention is to provide a process for preparation of a nutraceutical tortilla where some lactic bacteria keep their viability and probiotic property under the conditions that cooking is carried out.

It is a further object of the present invention to provide a process to obtain a nutraceutical tortilla wherein organic acids such as lactic acid and bacteriocins are produced during the fermentation steps therefore not requiring addition of preservatives during manufacturing.

Still a further object of the present invention is to provide a process for obtaining a nutraceutical tortilla wherein diacetyl and acetaldehyde are produced, providing the obtained product with a pleasant flavor and scent.

Other objects, particularities and advantages of the present invention will be apparent from the detailed description of certain embodiments and of the attached Figures, as well as from the attached claims.

### BRIEF DESCRIPTION OF THE FIGURES

Novel aspects which are deemed characteristic of the present invention will be specifically set forth in the attached claims. However, the invention itself both in its organization and method of operation together with other objects and advantages thereof will be better understood from the following detailed description of the embodiments of the present invention when read in relation to the attached drawings where:

FIG. 1 is a photograph that shows the recently prepared fermented wheat flour tortillas.

FIG. 2 is a photograph that shows the results from lactic bacteria count at different storage times.

FIG. 3 is a photograph illustrating the surface of a fermented wheat flour tortilla, taken by a JEOL JSM-6010LA scanning microscope, at 19 Kv and a working distance of 16 mm and a beam of 26. Bar: 50 μm×350.

FIG. 4 is a photograph illustrating the surface of a nutraceutical wheat flour tortilla taken by a JEOL JSM-6010LA scanning microscope, at 19 Kv and a 15 mm working distance and a beam of 26. Bar: 100 μ×100, showing starch pellets, lactic bacteria under growth in CO₂ bubbles produced by yeasts during fermentation and yeast under budding stage.

FIG. 5 is a photograph illustrating the inner part of a fermented wheat flour tortilla, taken by a JEOL JSM-6010LA scanning microscope, at 19 Kv and a working distance of 16 mm and a beam of 26. Bar: 10 μm×1500 where probiotic microorganisms may be noticed: bacteria grouped in clusters and chains (cocci and bacillus) and yeasts, trapped in CO₂ bubbles, supported on bacteria-produced gums.

FIG. 6 is a photograph illustrating the inner part of a nutraceutical wheat flour tortilla taken by a JEOL JSM-6010LA scanning microscope, at 19 Kv and a working distance of 16 mm and a beam of 26. Bar: 10 μm×1500, where starch pellets, lactic bacteria grouped in clusters (cocci) trapped in CO₂ bubbles, lactic bacteria grouped in chains (bacillus) trapped in CO₂ bubbles and yeasts are noticed.

FIG. 7 is a close up photograph of the inner part of a nutraceutical wheat flour tortilla taken by JEOL JSM-6010LA scanning microscope, at 19 Kv and a 15 mm working distance and a 26 beam. Bar: 10 μm×1500, showing lactic bacteria conglomerates supported in polysaccharide gums produced during starch and protein fermentation and gelatinization.

FIG. 8 is a picture illustrating a photograph close-up of another section of the inner part of a nutraceutical wheat flour tortilla taken by JEOL JSM-6010LA scanning microscope, at 19 Kv and a working distance of 16 mm and a beam of 26. Bar: 10 μm×1500 showing conglomerates of lactic bacteria supported in polysaccharide gums produced during fermentation and starch and protein gelatinization. It should be noticed that starch pellets when hydrolyzed form uniform and smooth structures where CO₂ is trapped.

FIG. 9 is a photograph illustrating the wheat flour dissolved in isotonic saline solution, used as positive control, taken by a JEOL JSM-6010LA scanning microscope, at 19 Kv and a 18 mm working distance and 35 beam. 100μm×100 Bar.

FIG. 10 is a photograph illustrating wheat flour dissolved in isotonic saline solution, used as positive control, taken by a JEOL JSM-6010LA scanning microscope, at 19 Kv and a 18 mm working distance and 35 beam. Bar: 100 μm×100.

FIG. 11 is a photograph illustrating a lactic bacteria culture grown in Rogosa broth (MRS), used as positive control, taken by a JEOL JSM-6010LA scanning microscope, at 19 Kv and a 18 mm working distance and 35 beam. Bar: 10 μm×1500.

FIG. 12 is a photograph illustrating the lactic bacteria culture grown in Rogosa broth (MRS), used as positive control, taken by a JEOL JSM-6010LA scanning microscope, at 19 Kv and a 18 mm working distance and 35 beam. Bar: 10 μm×1500.

FIG. 13 is a photograph illustrating the Saccharomyces cerevisiae yeast culture, grown in potato dextrose broth, used as positive control. Taken by JEOL JSM-6010LA scanning microscope, at 19 Kv and a 15 mm working distance and 35 beam. Bar: 10 μm×1500.

FIG. 14 is a photograph illustrating the Saccharomyces cerevisiae yeast culture grown in potato dextrose broth, used as positive control. Taken by JEOL JSM-6010LA scanning microscope, at 19 Kv and a 15 mm working distance and 35 beam. Bar: 10 μm×1500.

FIG. 15 is a photograph illustrating the Saccharomyces cerevisiae yeast culture grown in potato dextrose broth, used as positive control. Taken by JEOL JSM-6010LA scanning microscope, at 19 Kv and a 15 mm working distance and 35 beam. Bar: 10 μm×1500.

FIG. 16 is a graph showing the average values of Rollability effect in function of time, n=5, one-way analysis of variance (ANOVA), P<0.05, a vs b, P<0.05, a, b vs c.

FIG. 17 is a graph showing the average values of Stress effect in function of time, n=5, one-way analysis of variance (ANOVA), P<0.05, a vs b.

FIG. 18 is a graph showing the Breakdown Distances in function of time ±standard error mean, n=5, One-way analysis of variance (ANOVA), P<0.05, a vs b.

### DETAILED DESCRIPTION OF THE INVENTION

Novel features which are deemed characteristic of the present invention will be particularly set forth in the attached claims. However, the invention itself, both in its structure organization together with other objects and advantages thereof, will be better understood in the following detailed description.

The present invention is related to a nutraceutical food which at present is not available in the market, with a high nutritional value, low in calories and free of conservatives, that contributes to alleviate malnutrition and obesity, and can be stored without loss of nutrients, freshness, flavor and aroma.

The nutraceutical tortilla of the present invention is prepared from wheat flour to which two fermentations are carried out with probiotic microorganisms, lactic bacteria (Streptococcus thermophilus, Lactobacillus bulgaricus, Lactobacillus plantarum) and with Saccharomyces cerevisiae yeast, added with prebiotics (inulin) and enriched with milk protein, calcium and folic acid, resulting in a high nutritional value product and with probiotic microorganisms.

Following are listed the ingredients used in manufacturing tortillas and the characteristics and functionality supplied by each ingredient, which were taken into account for formulation of the product of the present invention.
Wheat flour present in the product in a percentage from 50 to 55%

A Base Flour for manufacturing tortillas, with carbohydrate and proteins such as gliadin and glutenin conferring elasticity to the dough regardless of their low content.
Cow milk fermented with lactic culture (lactic bacteria and yeasts) present in the product in a percentage from 32 to 36%

Lactic bacteria (BAL) are probiotic microorganisms that prevent diseases and produce a wellness effect in host's health; lactic bacteria ferment lactose, present in milk products and derivatives, producing lactic acid (pH de 4 a 5), organic acids, bacteriocins, which are defined as protein-origin peptides that at low concentrations show a wide potential as preservatives by inhibiting growth of other microorganisms, thus they are used as natural antimicrobial agents in food preservation and at a given time they could replace to synthetic preservatives. Another feature of lactic bacteria is the production of aromatic compounds, diacetyl and acetaldehyde, which when added to final product characteristics provide a pleasant flavor and scent and increase the nutritional value by the protein content contained in their cell structures.

BALs are classified according to their optimal growth temperature, in mesophiles from 30 to 45° C. or in thermophiles from 55 to 75° C. For example, Streptococcus thermophilus, its optimal growth temperature is from 37 to 40° C., but it may withstand a temperature range from 50 to 65° C. during half hour. In case of Lactobacillus bulgaricus, its optimal temperature is from 37 to 42° C. and may withstand up to 42 to 45° C.

Lactobacillus plantarum, L. lacticus and S. termophilus are bacteria characterized by quickly acidifying the media where they grow, while L. plantarum is characterized by being a probiotic with good adherence capacity to intestinal mucosa in mammals while being heterofermentative and facultative anaerobe.

In the case of the yeast, it hydrolyzes starch present in wheat tortilla and generates aromatic, foamy and elastic dough which is important since by adding fiber to flour it tends to become brittle which counteracts during fermentation with this yeast. Additionally, it acts as a probiotic and increases protein and vitamins of the B group contents.
Inulin present in the product in a percentage from 3.5 to 5.5%

Inulin is a natural soluble dietary fiber, it has a prebiotic activity since it promotes the growth of beneficial organisms for health and their inclusion in the daily diet is of great importance since it reaches the intestine almost undigested, stimulating bowel peristaltic motion, regulating intestinal transit and improving the overall sense of well-being in the person who consumes it. It lowers cholesterol, improves absorption of calcium, magnesium and phosphorus, helps to balance the levels of insulin in the blood and inhibits triglyceride accumulation in the liver thus reducing the risk of atherosclerosis. Another of its great qualities is the low caloric value that is present. In a preferred embodiment of the invention said inulin is from heart of blue agave, Tequilana weber.
Whey solids (SSL by its Spanish acronym) present in the product in a percentage from 3.0 to 3.5%

The use of cow whey solids in the manufacture of tortillas increases the nutritional value due to its high content of globular proteins: β-lactoglobulin, α-lactoalbumin, seroalbumin, immunoglobulins, lactoferrin and glucomacropeptides which participate in immune system and have a high content of essential amino acids, other components comprising the SSL are lactose (necessary for lactic bacteria growth), minerals and low fat content. It further has the advantage of being low cost and with high market availability.

They are widely used ingredients in pharmaceutical or food industry or as protein ingredients and for its excellent water binding ability, ions and small molecules to improve the physical and functional properties of various foods, such as viscosity, foam, enhancing emulsions, preventing moisture loss, improving texture and most importantly, increasing their nutritional value. The SSL are generally considered safe (GRAS status).
Calcium chloride (CaCl₂) present in the product in a percentage from 0.5 to 0.7%

Calcium chloride (CaCl₂) is a calcium salt frequently used as food additive since it is a synthetic stabilizer and flavor enhancer, retaining moisture and improving food texture. During its metabolism in the body it is decomposed in calcium and chlorine ions. Calcium is physiologically important for the nervous system in the formation of bones and muscle contraction. Lack of calcium can reduce signals that go from brain to muscles, lack of calcium in the body weakens the muscles, and the heart may beat irregularly; chloride ions regulate blood pH balance, and help control the levels of body fluids, as well as act as a preservative in the final product. Calcium reduces the degree of degradation of starch by a-amylase and modifies the ionic strength greatly influencing the kinetics of gelation of serum protein and flour, which leads to a significant variability in the hydrolytic potential of a-amylase in wheat starch.
Folic acid present in the product in a percentage from 0.003 to 0.005%

Folic acid, folate or vitamin B₉, necessary for structural protein and hemoglobin formation is effective in treatment of certain anemia. It is indispensable during cell growth (pregnancy and adolescence) and for DNA and RNA synthesis.
Olive oil present in the product in a percentage from 2.8 to 3.5%

Olive oil is a highly energetic food (9 kcal/g), having a high monounsaturated fatty acid content (77.5%) where oleic acid represents 68.0%, and 9.5% is for myristic, palmitic, palmitoleic, heptadecanoic, heptadecenoic, stearic, linoleic, linolenic, arachidonic, icosenoic, behenic, lignoceric, as well as 16.2% of saturated fatty acids and 6.3% of polyunsaturated fatty acids, whereby it is considered a monounsaturated fat, but beyond its high energy content it shows positive effects for consumer's health which become it into a functional food being associated with a lower risk of cardiovascular disease, obesity, metabolic syndrome, type II diabetes, high blood pressure, cancer and with protection against brain disorders and age-related diseases.
Sucrose present in the product in a percentage from 2.0 to 3.0% and Sodium chloride present in the product in a percentage from 0.5 to 0.7% Steps to carry out the process of the present invention are shown below:
a) Inoculate pasteurized milk with lactic culture (lactic bacteria) during 10 to 14 hours at 45±0.5° C., under anaerobic conditions;
b) Activate the yeast solubilizing the yeast in pasteurized milk incubating at 20±0.5° C., during 10 to 15 hours;
c) Mix the inoculated pasteurized milk of step a) with the pasteurized milk where yeast of step b) was activated;
d) Mix the dry ingredients;
e) Add olive oil followed by milk obtained in step c);
f) Knead until forming a lump-free dough;
g) Form dough balls with a weight of 30±0.5 g;
h) Let stand the dough balls (yeast fermentation) at a temperature from 20 top 25° C. during 3.0 to 4.0 hours;
i) After fermentation dough balls are pressed until shaping a tortilla of 14-15 cm diameter;
j) Cook at a temperature from 60 to 65° C., during 15 to 20 seconds each side adding flour to prevent burning;
k) Packaging in a tight closure bag, removing all the air to form a vacuum.

The product should be preferably kept at room temperature from 20 to 25° C. in a fresh and dry place. Shelf life of this product is up to 40 days at room temperature and up to three months under refrigeration.

There is a large variety of both corn and wheat tortillas in the market to which a mixture of fibers including inulin has been added, however, there are no tortillas within the state of the art where two fermentation processes are carried out, an alcoholic fermentation produced by yeast (Saccharomyces cerevisiae) and a lactic fermentation produced by lactic bacteria (Streptococcus thermophilus, Lactobacillus bulgaricus, Lactobacillus plantarum). During alcoholic fermentation Saccharomyces cerevisae hydrolyzes starches of the wheat flour into glucose molecules which are transformed into ethanol (which is evaporated during cooking) and carbon dioxide (CO₂), resulting in foamy, soft and elastic dough, product of binding wheat proteins, gliadin and glutenin, (gliadin is sticky and provides gluten its adhesive quality, while glutenin confers tenacity and strength). These two proteins form a three dimensional network favored by pH decrease produced by organic acids (pyruvic and lactic) during lactic fermentation.

CO₂ that is trapped into the dough favors lactic bacteria growth by generating optimal conditions for anaerobiosis and a microaerophilic environment which in addition to a high nutrient concentration allows probiotic microorganisms to keep alive, grow and reproduce.

On the other hand, during lactic fermentation, the homofermentative bacteria as defined by their name, transform starch and lactose present in milk into lactic acid, while heterofermentative bacteria besides lactic acid also produce ethanol, acetic acid, acetoin, diacetyl, acetaldehyde, 2,3 butanediol and CO₂, compounds which are responsible of flavor, scent and texture of the dough. Lactic acid with acetic acid reduce the pH down to a level that provides antimicrobial properties to the final product, proving an advantage for conservation of tortillas since it is not necessary to use preservatives to give them a life of up to 40 days at room temperature and up to three months under refrigeration.

It has been reported in the literature that lactic bacteria show an irregular behavior in stability when heat is present, they are generally classified as cold-resistant microorganisms however, there are studies which demonstrate their resistance at high temperatures. Noskowa, 1972, reported that lactobacilli contained in milk are capable of withstanding temperatures of 71° C. during 17 seconds and even higher temperatures.

In case of Streptococcus thermophilus, its range of growth temperature is from 37-40° C., but it may withstand from 50 to 65° C. during half hour (Gobbetti et al., 2005). Lactobacillus bulgaricus and Lactobacillus plantarum, according to their optimal growth temperature are classified in mesophiles (30 to 45° C.) or thermophiles (55 to 75° C.). Both lactic bacteria (Streptococcus thermophilus, Lactobacillus bulgaricus and Lactobacillus plantarum) and yeast Saccharomyces cerevisiae, possess probiotic properties, (Gerald W, 2005) which are beneficial for consumer health which effects are enhanced when adding inulin fiber as prebiotic agent, resulting in a symbiotic food with unique functional properties and different from those shown by both corn and wheat flour traditionally consumed tortillas, and considering its high nutritional value results in a food useful to fight diseases such as malnutrition and due to its low caloric value and its symbiotic characteristics useful to help controlling overweight, obesity and accordingly some diseases such as Diabetes mellitus.

Another important quality to remark in the present invention is that due to the conditions at which cooking is carried out (temperature of 60-65° C.), lactic bacteria keep their viability and probiotic property (1×10⁶ UFC/mL); also, organic acids such as lactic acid and bacteriocins are produced during fermentations therefore addition of preservatives is not required during preparation and because of diacetyl and acetaldehyde production it is a product with delicious flavor and scent. The sum of all these qualities results in a product with nutraceutical properties which has not been previously manufactured.

It is important to highlight that the consumption of tortillas in the present invention due to its high nutrimental value decreases indices of malnutrition and obesity, however, that does not mean that persons who develop diseases such as Diabetes mellitus are healed by eating them.

The present invention will be better understood from the following examples, which are only shown for illustrative but not limitative purposes thereof, in order to allow a full understanding of the preferred embodiments of the present invention, without involving that other non-illustrated embodiments may be present which may be put in practice based on above detailed description.

### Examples

The following examples are described to carry out the invention as well as to evaluate it; they are only illustrative in nature but not limitative of the scope of the invention.

### Methodology

### Preparation of Fermented Milk and Yeast Activation.

Fermented milk was obtained by inoculating pasteurized milk with lactic culture, incubated during 12 hours at 45±0.5° C., under anaerobic conditions. Yeast activation is carried out by solubilizing the same in pasteurized milk and incubated at 20±0.5° C., during 12 hours. They are mixed after this time is elapsed and used in the amounts reported in Table 1 which shows the formula and composition in percentage of each of the ingredients used to prepare the dough of wheat flour tortillas.

TABLE 1
Dough formula used to prepare the nutraceutical
tortillas in percentage (%).

| Ingredients | Percentage (%) |
|---|---|
| Wheat flour | 51.280 |
| Whole cow milk fermented with lactic culture | 34.110 |
| (lactic bacteria and yeast) | |
| Inulin | 4.360 |
| Whey solids | 3.320 |
| Olive oil | 3.110 |
| Sucrose | 2.570 |
| Table salt | 0.640 |
| Calcium chloride (CaCl₂) | 0.610 |
| Folic acid | 0.004 |

### Dough Preparation

Weigh each of the ingredients according to the number of tortillas intended to manufacture in accordance with the contents of Table 1, mix perfectly all the dry ingredients, add oil followed by fermented milk, knead until forming a lump-free homogeneous, soft and elastic dough. Form dough balls of 30±0.5 g weight, let stand (yeast fermentation) at room temperature (22 to 25 ° C.), from 3.0 to 4.0 hours. After fermentation dough balls are pressed until forming a tortilla with 14-15 cm diameter, cook at a temperature of 60 to 65° C., during 15 to 20 seconds for each side adding flour to prevent burning. Once cooked, 10 tortillas were hot-packaged in a polyethylene bag with tight closure, assuring to remove all the air to form a vacuum, keeping the product at room temperature in a fresh and dry place. Shelf life of this product is of up to 40 days at room temperature and up to three months under refrigeration.

### Lactic Bacteria Count

Count of lactic bacteria tortilla samples stored at different times from 0 to 90 days and room temperature and under refrigeration were taken, 10 g of sample are taken and diluted into 90 mL of saline solution, 10⁻ to 10⁻¹³ dilutions were prepared and massively seeded in agar Rogosa culture media (MRS, Becton Dickinson) and cultured in a temperature range from 45±0.5° C. under anaerobic conditions during 72 hours. While in case of yeasts those were seeded in potato dextrose agar media (PDA, Becton Dickinson) and incubated at 28±0.5° C. during 48 hours, time after which the count of bacteria and yeasts was carried out (UFC/mL).

### Analysis of Texture Profile

Rollability, stress strength and extensibility tests were carried out, measured as breakdown distance; a Brookfield model CT3 texture meter with a 4500-g load cell was used for these tests.

### Rollability Test.

It is a texture test consisting in using a platform with a rotating cylinder with dimensions of 160 mm long, and 5 mm in diameter, where the tortilla is wrapped by an elastic band that holds it. Cylinder is attached to the mobile arm of the texture meter through a thread. By raising the arm of the texture meter, the cylinder is rotated which causes that the tortilla attached thereon is wrapped. Before testing the device on the texture meter platform is placed and thread is attached to the mobile arm of the same with an attachment for this purpose. The mobile arm is calibrated with the base so that the test is performed at a rate of 3 mm/s and load of activation of 1 g, for a distance of 90 mm. The equipment shows a load force graph (g) per time deformation (s). The rollability test is conducted on recently prepared tortillas once they reached room temperature (20±2° C.).

### Stress Test.

Sample is previously cut and held by tweezers that are placed on the texture meter and thus the sample is pressed by the upper and lower part. With distance conditions of 100 mm from the arm and at a rate of 3 mm/s and activation of 1 g load, so that the arm goes up, which causes that the sample is subject to two opposing forces. Therefore the result in units of miliJoule (mJ).d is obtained

### Breakdown Distance.

Once the stress strength is known, the breakdown distance traversed until cutting of the piece (mm), expressed as extensibility.

### Physicochemical Analysis

pH at different times of tortilla manufacture was determined, from day zero an later every 3 days up to 30 days of storage. The equipment used for this analysis was a HANNA pH meter, model pH 213, with an electrode installed with its support-arm and a temperature probe.

### Proximate Chemical Analysis

The proximate chemical analysis of tortilla samples included, moisture percentage, contents of carbohydrate, protein, fiber, fat, calcium, folic acid and minerals.

Moisture. Moisture was assessed according to method 920.151 (AOAC, 2005), at different storage times, from day zero and later every 3 days until 38 days of storage.
Protein. Protein was determined by method 920.87 (AOAC, 2005).
Fat. Fat determination was carried out by method 920.85 (AOAC, 2005).
Dietary fiber. Fiber was determined by method 992.16 (AOAC 2005).
Calcium. Calcium was determined by method 991.25 (AOAC 2005).
Minerals. The method used was 930.05 (AOAC 2005).
Folic acid. Determined by a method developed by Albdalá-Hurtado, et al, 1997.
Carbohydrate. Total digestible carbohydrates were calculated by difference.

### Scanning Electronic Microscopy

A JEOL JSM-6010LA scanning microscope was used at 19 Kv and a working distance of 15-18 mm and a beam of 25-35, Bar 10, 50, 100 μm×100, 350 and 1500. Control samples were observed (wheat flour pellets, lactic bacteria, yeasts, fermented dough) and samples of wheat flour tortilla fermented with lactic bacteria and yeasts, with a preparation time of 7 days.

### Microbiological Analyses

Microbiological analyses were conducted in order to assess tortilla innocuity in accordance with Mexican Official Standard NM-187-SSA1/SCF1-2002, Products and Services. Dough, tortillas, fried tortillas and prepared flours for preparation and establishments where those are processed.

### Sensory Evaluation

A tasting panel was held to assess the degree of acceptance of tortillas. Sensory evaluation was performed an hour after tortillas were elaborated. A degree of acceptance test was applied with 50 non-trained judges. The judges' panel are regular consumers of tortillas, formed by students, faculty, researchers, staff and maintenance of FESC-1, UNAM, between 18 and 57 years old.

### Statistical Analysis

A sample size n=5 was used, all data are presented as mean +/− standard error, rollability, stress, distance, half-life time was calculated using a one-way analysis of variance (ANOVA) with repeated measures, followed by a post hoc Student Newman-Keuls test, differences were deemed significant when (p<0.05). Statistical tests were carried out using the Sigma Plot 13 program (Jandel Corp., SPSS Inc., San Rafael, Calif., USA).

### Results and Discussion

FIG. 1 shows a photograph of wheat flour fermented freshly made tortillas. The ranges of application of each component used in the formulation of the tortillas are presented in table 2, it is worth highlighting that microbiological results comply with provisions of NOM-187-SSA1/SCF1-2002, so that we can ensure that this food is safe and harmless to consumers (results are not shown).

TABLE 2
Application ranges defined in NOM-187-SSA1/SCFI-
2002, for each component used in the formulation.

| | Mexican Official Standard |
|---|---|
| | NM-187-SSA1/SCFI- |
| | 2002, Products and Services. |
| | Dough, tortillas, fried |
| | tortillas and prepared flours |
| | for preparation and establishments |
| Components | where those are processed |
| Wheat flour | GMF |
| Whey solids | GMF |
| Fiber: Inulin obtained from the heart | GMF |
| of blue agave, Tequilana weber | |
| variety | |
| Folic acid | GMF |
| Calcium Chloride (CaCl₂) | GMF |
| Sucrose | GMF |
| Olive oil | ≤2.0% |
| Table salt | GMF |
| Yeast (Saccharomyces cerevisiae) | GMF |
| Lactic bacteria | GMF |
| Milk | GMF |

GMP. Good Manufacturing Practices

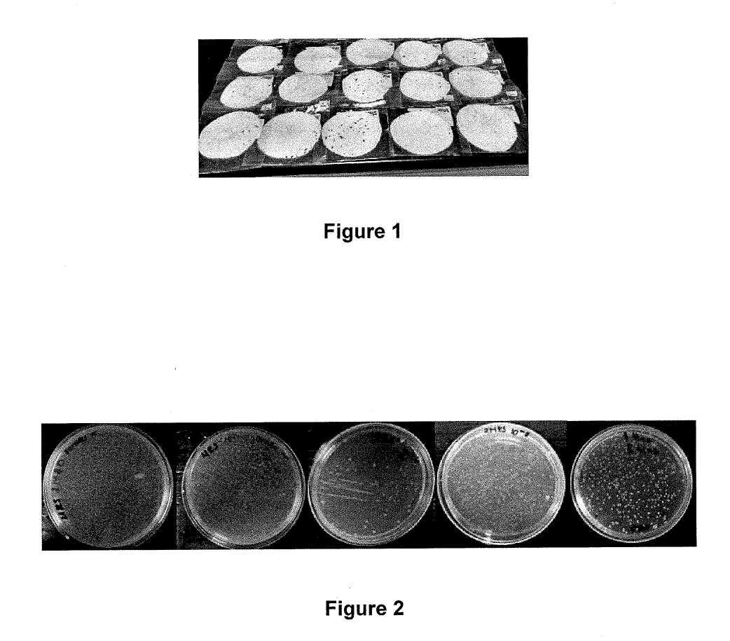

Results from lactic bacteria count at different storage times are shown in Table 3 and in the series of FIG. 2 photographs; note that probiotic bacteria are kept alive after cooking, this is achieved provided that cooking temperatures in the range from 60 to 65° C. are used and time is from 15 to 20 seconds on each side of the tortilla, the fact that lactic bacteria are kept alive after being subject to a thermal process is explained when lactic bacteria are exposed to heat shock; as a response to this extreme condition a group of proteins known as “heat shock evolutionary conservation” (HSPs) are synthesized, which promote the proper folding of recently formed polypeptides, assembly, degradation and translocation of complex proteins.

On the other hand, De Angelis, et al., (2004), studied the heat shock response in Lactobacillus plantarum strains isolated from cheeses and yeasts finding a quite similar response. When Lactobacillus Plantarum cells under intermediate exponential phase were adapted at 42° C. during 1 h, the thermal resistance increased up to 72° C. for 90 seconds and the protein expression analysis in control cells and adapted to heat showed changes in expression level of 31 and 18 proteins, proteins were identified as, DnaK, GroEL, triggering factor, ribosomal proteins L1, L11, L31 and S6, HIbA of DNA-binding protein II, and CspC.

TABLE 3
Viability of probiotic bacteria at different times.

| Manufacturing | Lactic bacteria | Yeasts |
|---|---|---|
| date (Days) | (UFC/g sample) | (UFC/g sample) |
| 0 | 8 × 10¹³ | 4 × 10¹³ |
| 10 | 4 × 10⁷ | 9 × 10⁴ |
| 20 | 5 × 10⁶ | 8 × 10⁴ |
| 30 | 5 × 10⁶ | 5 × 10³ |
| 40 | 7 × 10⁶ | 6 × 10³ |
| 50 | 7 × 10⁶ | 6 × 10³ |
| 60 | 7 × 10⁵ | 6 × 10³ |

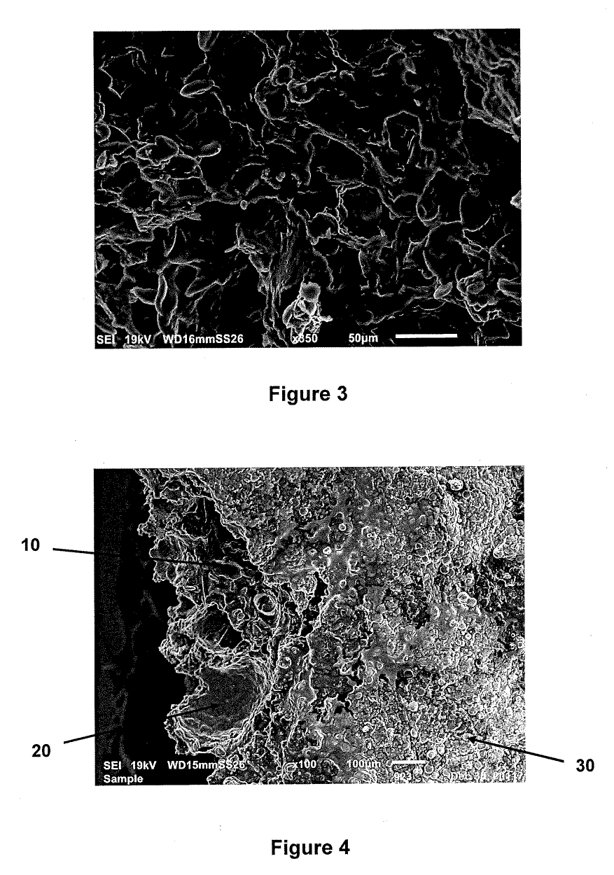

FIG. 3 is a photograph illustrating the surface of a fermented wheat flour tortilla, taken by a JEOL JSM-6010LA scanning microscope, at 19 Kv and a working distance of 16 mm and a beam of 26. Bar: 50 μm×350; and FIG. 4 is a photograph that shows the surface of a nutraceutical wheat flour tortilla also taken by said scanning microscope; in said FIG. 4 Starch pellets 10, Lactic bacteria 20 under growth in CO₂ bubbles produced during fermentation and yeast 30 under budding step are shown and indicated.

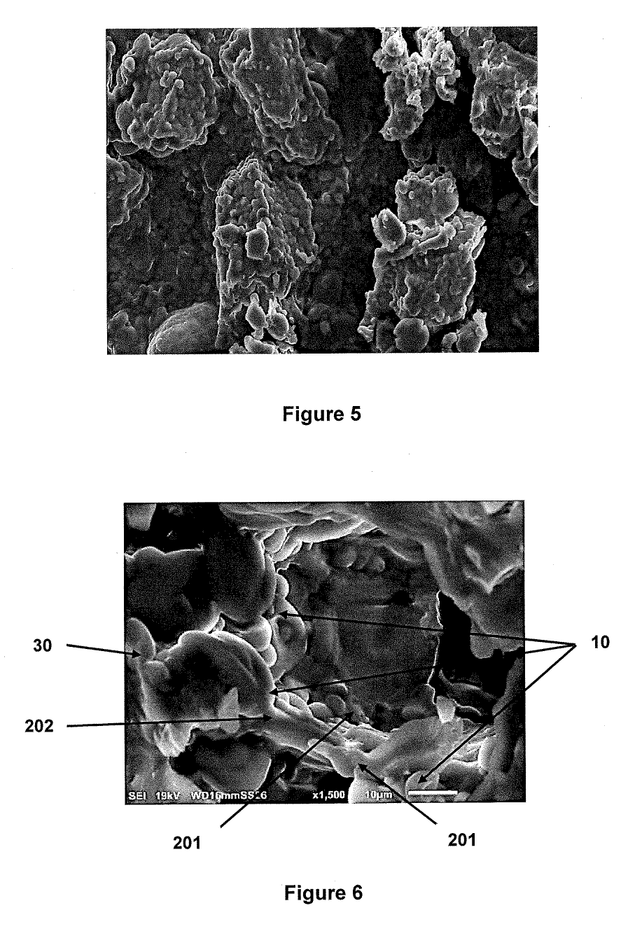

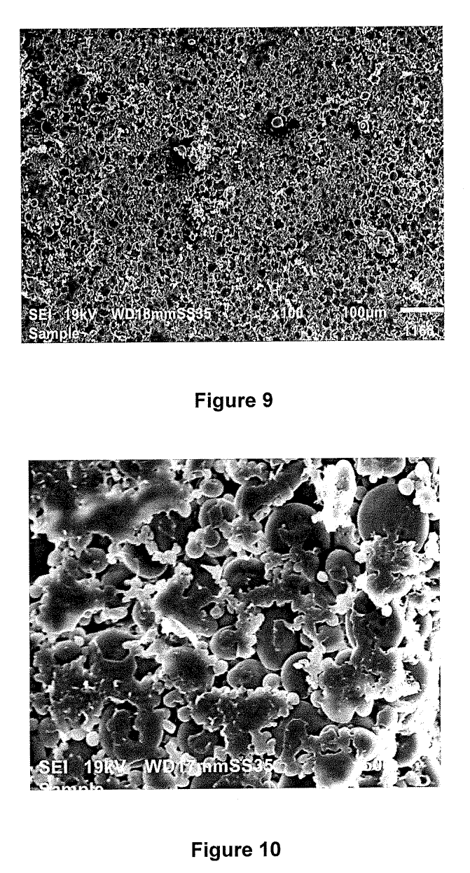

In relation to such FIGS. 3 and 4, you will notice that the starch is not in the form of granules as shown in FIGS. 9 and 10 photographs, said Figures showing the wheat flour dissolved in isotonic saline solution used as positive control; this has been hydrolyzed forming a uniform, smooth, soft dough and with few granules of starch, while the picture in FIG. 5 corresponds to the inner part of the tortillas, where probiotic bacteria are grouped into clusters and chains (cocci, bacillus and yeasts) remaining occluded in CO₂ bubbles, supported on gums produced by bacteria.

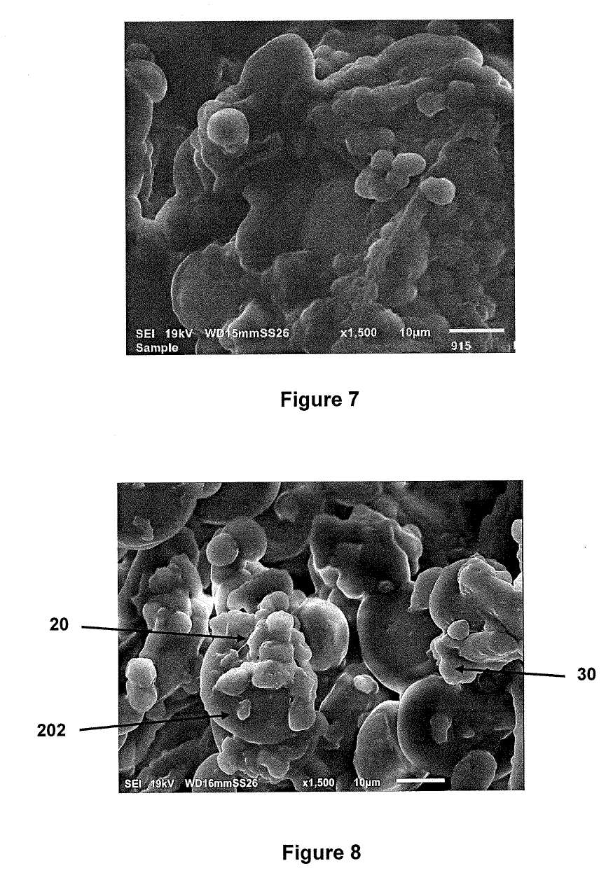

FIGS. 6 to 8 show photographs that illustrate the inner part of a nutraceutical wheat flour tortilla taken by a scanning microscope, where voids may be noticed which are just CO₂ bubbles produced during fermentation by yeasts and lactic bacteria, precisely in these gaps is where bacteria find the optimal anaerobic or microaerophilic conditions for growth and reproduction because of the high nutrient content.

Photograph in FIG. 6 is a photograph where pellets 10, lactic bacteria grouped in clusters (cocci) 201 trapped in CO₂ bubbles, lactic bacteria grouped in chains (bacillus) 202 trapped in bubbles CO₂ and yeast 30 may be observed.

FIG. 8 is a photograph illustrating a photograph close-up of another section of the inner part of a nutraceutical wheat flour tortilla taken by a scanning microscope, showing conglomerates of lactic bacteria 20 supported on polysaccharide gums produced during fermentation and gelatinization of starch and proteins. It should be noticed that starch pellets when hydrolyzed form uniform and smooth structures where CO₂ is trapped. In similarity to FIG. 6, lactic bacteria are indicated as grouped in chains (bacillus) 202 trapped in bubbles CO₂ and yeast 30.

FIGS. 9 and 10 show photographs of starch positive controls dissolved in isotonic saline solution, both Figures illustrate wheat flour dissolved in isotonic saline solution, used as positive control. Photographs were taken by JEOL JSM-6010LA scanning microscope, at 19 Kv and 18-mm working distance and 35 beam. Bar: 100 μm×100.

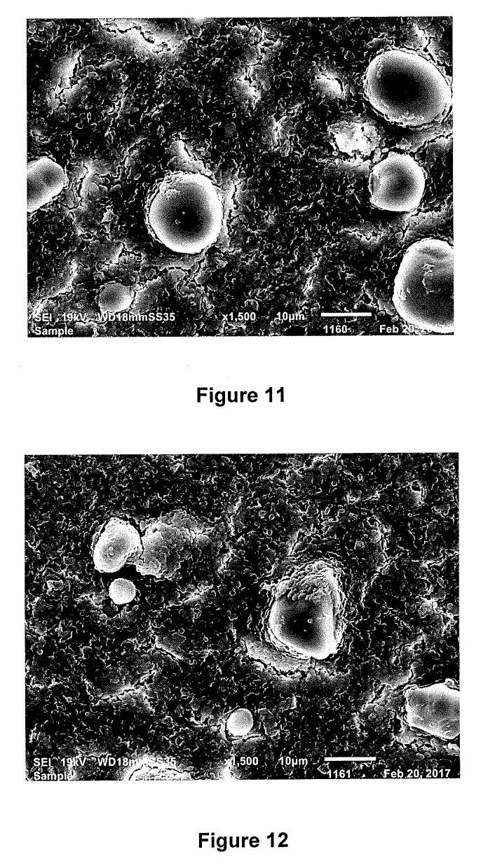

FIGS. 11 and 12 correspond to photographs illustrating a lactic bacteria culture dissolved in isotonic saline solution, lactic bacteria grown in Rogosa broth (MRS), used as positive control. Said photographs were taken by JEOL JSM-6010LA scanning microscope, at 19 Kv and 18-mm working distance and 35 beam. Bar: 10 μm×1500.

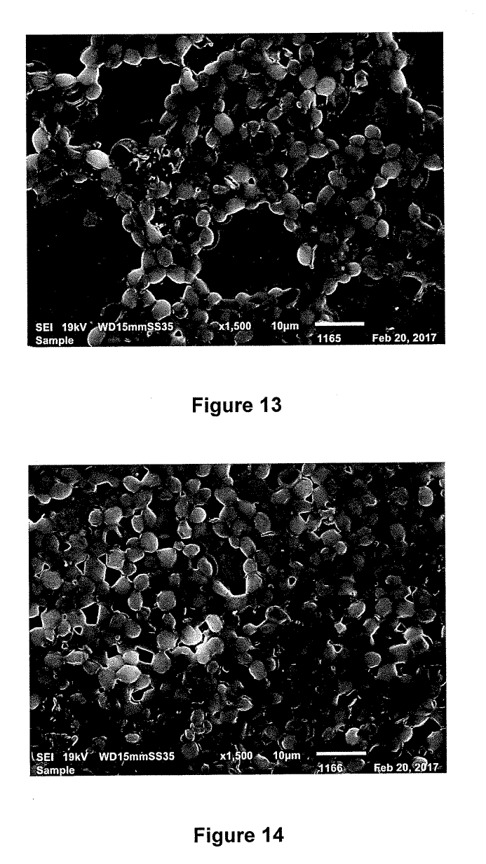

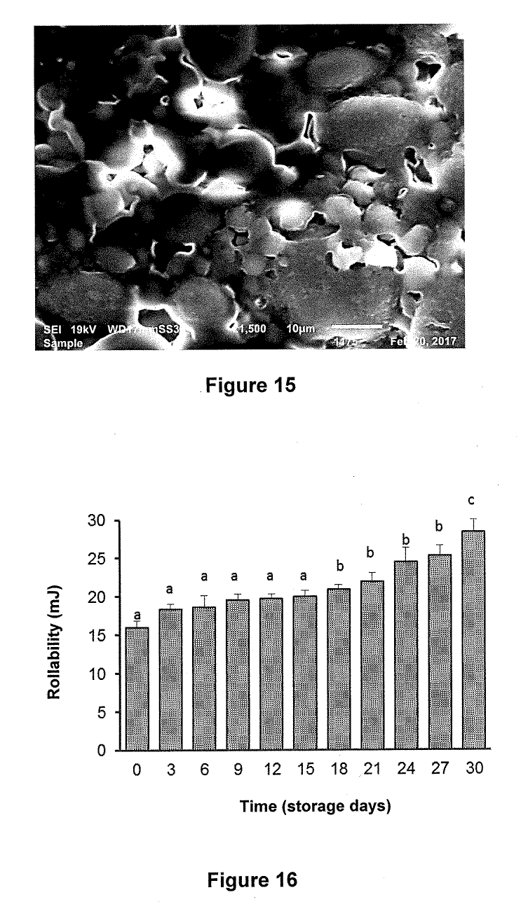

FIGS. 13, 14 and 15 illustrate photographs showing the positive controls of Saccharomyces cerevisiae yeast (Saccharomyces cerevisiae yeast culture grown in potato dextrose broth). Photographs taken by a JEOL JSM-6010LA scanning microscope, at 19 Kv and a 15 mm working distance and 35 beam. Bar: 10 μm×1500.

Physicochemical changes presented in tortillas at different times where observed that humidity remains unchanged over time (30 days) are shown in Table 4. The moisture content of starch-based products is related to the softness of these, while its loss is associated with drying and hardening. The fact that there are no significant changes in the moisture content may relate to the use of whey solids, of which there are reports indicating that those improve the physical and functional properties of various foods, increase the viscosity, favor the formation of emulsions, improve texture, prevent moisture loss and more importantly increase the nutritional value.

TABLE 4
Parameters assessed to determine tortilla shelf life

| Storage | | | | | |
|---|---|---|---|---|---|
| time (Days) | Rollability (mJ) | Stress (mJ) | Distance (mm) | Moisture (%) | pH |
| 0 | 16.842 ± 0.787 | 19.195 ± 0.962 | 9.00 ± 0.374 | 23.266 ± 0.742 | 6.20 ± 0.549 |
| | (a) | (a) | (a) | (a) | (a) |
| 3 | 18.357 ± 0.675 | 18.648 ± 0.588 | 8.00 ± 0.633 | 23.262 ± 0.319 | 6.08 ± 0.367 |
| | (a) | (a) | (a) | (a) | (a) |
| 6 | 18.616 ± 1.485 | 18.488 ± 0.625 | 6.00 ± 0.316 | 24.002 ± 0.001 | 6.16 ± 0.687 |
| | (a) | (a) | (a) | (a) | (a) |
| 9 | 19.563 ± 0.754 | 18.407 ± 0.862 | 4.75 ± 0.245 | 21.930 ± 0.581 | 6.12 ± 0.437 |
| | (a) | (a) | (b) | (a) | (a) |
| 12 | 19.690 ± 0.670 | 18.390 ± 0.305 | 4.66 ± 0.374 | 21.881 ± 0.468 | 6.09 ± 0.570 |
| | (a) | (a) | | (a) | (a) |
| 15 | 20.037 ± 0.724 | 18.373 ± 1.248 | 4.33 ± 0.250 | 21.251 ± 0.002 | 6.01 ± 0.419 |
| | (a) | (a) | (b) | (a) | (a) |
| 18 | 20.913 ± 0.588 | 17.057 ± 1.031 | 4.33 ± 0.010 | 20.982 ± 0.234 | 6.04 ± 0.626 |
| | (b) | (a) | (b) | (a) | (a) |
| 21 | 21.937 ± 1.121 | 14.072 ± 0.986 | 3.50 ± 0.239 | 20.840 ± 0.264 | 5.98 ± 0.433 |
| | (b) | (b) | (b) | (a) | (a) |
| 24 | 24.443 ± 1.864 | 14.040 ± 0.775 | 4.25 ± 0.367 | 20.880 ± 0.832 | 5.92 ± 0.386 |
| | (b) | (b) | (b) | (a) | (a) |
| 27 | 25.275 ± 1.289 | 13.738 ± 0.956 | 3.25 ± 0.354 | 20.400 ± 0.567 | 5.65 ± 0.433 |
| | (b) | (b) | (b) | (a) | (a) |
| 30 | 28.340 ± 1.599 | 13.143 ± 0.756 | 3.01 ± 0.461 | 20.320 ± 0.213 | 5.23 ± 0.316 |
| | (c) | (b) | (b) | (a) | (a) |

*Different letters P < 0.05, a vs b, P < 0.05, a, b vs c. One-way analysis of variance (ANOVA) with repeated measures, n = 5.

In case of rollability of tortillas such property is related with tortilla flexibility and is kept stable for a period of 21 days, time after which there are significant changes in such property. This fact may be noticed from graph in FIG. 16, a graph which shows average values of Rollability effect in function of time, n=5, one-way analysis of variance (ANOVA), Different letters P<0.05, a vs b, P<0.05, a, b vs c.

Rollability or rolling test allows knowing the force needed to wrap the tortilla without being broken and thus forming the taco, where the softer and more flexible the tortilla is, the easier the tortilla will be rolled.

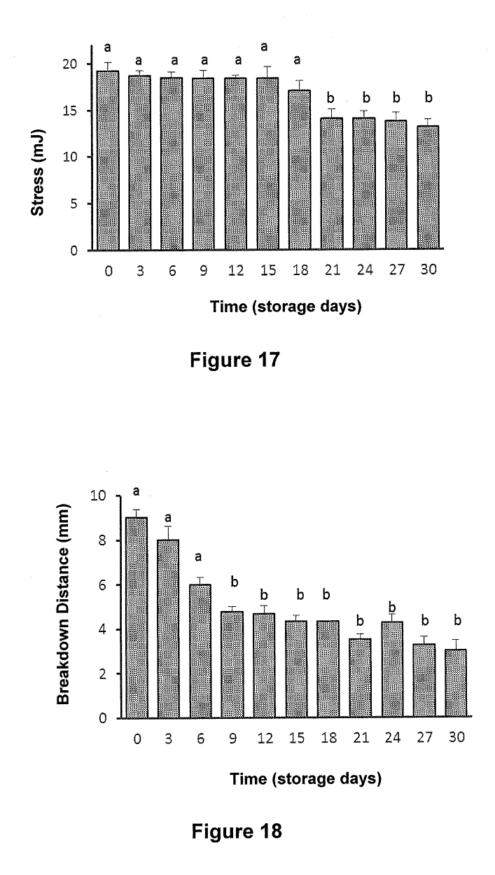

In connection with the stress tests, stress is kept without significant changes until 21 days, as may be noticed from FIG. 17 showing a graph with average values of stress effect in function of time, n=5, one-way analysis of variance (ANOVA), Different letters P<0.05, a vs b.

This test indicates the maximum force required to break the tortilla when subject to two forces opposed and is carried out to determine the food weight to be supported by the tortilla, the fact that rollability is kept without changes during 21 days supports what has been previously described, that a soft, smooth and foamy elastic dough is formed during lactic and alcoholic fermentation.

Finally, the breakdown distance is modified after 9 days, a graph with results from Breakdown Distance test in function of time is shown in FIG. 18, illustrating the Breakdown Distances in function of time±mean of standard error, n=5, One-way analysis of variance (ANOVA), Different letters P<0.05, a vs b.

It is worth to comment that some features such as rollability, stress and distance is recovered when the tortilla is slightly moisturized with water before reheating, and that heating should be carried out at low temperatures to conserve the viability of bacteria and yeasts.

Results from described example showed the preparation of a foamy, elastic, aromatic dough and with a high nutritional value, proteins, fats, fiber, calcium and folic acid; after cooking step which was carried out during 15 to 20 seconds for each side of the tortilla at a temperature of 60-65° C., the viability of lactic bacteria and yeasts was kept (1×10⁶ UFC/g and 1×10³ UFC /g respectively) for up to 30 days after manufacturing.

Lactic bacteria into the gastrointestinal tract have a symbiotic effect with inulin, conferring well-being and health to the host; also, aromatic-type compounds are generated during fermentation which confer flavor and scent to the end product.

The results showed that moisture is kept without significant changes for up to 30 days after being manufactured, while rollability or rolling (capability of the tortilla to be rolled without breaking) is kept without any changes during the first 18 days, there are significant changes in rollability from day 21, in the case of stress; significant changes were noticed in the case of distance (elasticity) from the ninth day after the manufacturing date.

It is suggested to moist the tortilla before heating for consumption in order to prevent any loss in rollability and stress.

Finally, examplary results showed that shelf life of tortillas is up to forty days at room temperature and ninety days under refrigeration, which confirm previous comments: lactic acid, other organic acids and bacteriocins produced during fermentation act as natural preservative and does not require further the use of stabilizers (gums) to keep them soft.

### Sensory Evaluation

Tortillas were evaluated using a hedonic scale structured with several points to indicate the level of pleasure in a consumer as response parameter. The results of the test carried out are shown in Table 5, it should be noted that results showed the top rating on the evaluated parameters of quality, color, appearance, scent, taste, sensation in the mouth and overall acceptability, and is worth mentioning that after filling out questionnaires the panelists requested more samples to taste.

TABLE 5
Results from sensory analysis conducted on 50 panelists.

| | Wheat flour nutraceutical |
|---|---|
| Quality parameter | tortillas |
| Color and appearance | 7 |
| Scent | 7 |
| Flavor | 7 |
| Mouth sensation | 7 |
| General Acceptability | 7 |

Table 6 shows that the nutritional value of a 28-g piece of tortilla is high as to protein content (3.0 g), a fiber content of 1.12 g; it is worth to remark that wheat flour tortillas are not available in the market with such fiber and protein content, which makes them attractive for the purpose developed: to prevent malnutrition and to fight obesity when having a tortilla with these characteristics (free of empty calories).

TABLE 6
Nutritional provision by portion of a 28-g piece of tortilla.
Proximate Chemical Analysis

| | | | | |
|---|---|---|---|---|
| Protein | Carbohydrates | Total fat | Fiber | Calcium |
| 3.0 g | 14.60 g | 1.20 g | 1.12 g | 13.78 mg |
| | | Unsaturated | | Folic acid |
| | | 0.78 g | | 10.26 μg |
| | | Saturated | | Minerals |
| | | 0.42 g | | 0.478 g |

Calories per 28-g portion ~80.0 Kcal

According to above disclosure, it may be noticed that a wheat flour tortilla has not been disclosed in the state of the art where fermentation steps with probiotic microorganisms are included in its manufacturing process which further withstand cooking and once packaged those are kept viable, providing advantages and differences regarding the state of the art.

Other novelties of the present invention is that organic compounds produced during fermentation process (lactic acid, acetic acid, bacteriocins, diacetyl, acetaldehyde, etc.), confer a high shelf life thus they may show a storage time without any addition of preservatives of up to 40 days without refrigeration and 90 days when kept under refrigeration. They also provide an excellent flavor, scent, and texture and when further adding fiber (inulin) and probiotic bacteria confer a beneficial effect to health of malnourished and obese persons.

Another of its qualities is that the energy value provided is due to (empty calorie-free) added nutrients, such as protein of milk, and whey solids rich in protein, calcium, folic acid, unsaturated fatty acids and nutrients contained in the added bacteria and yeasts.

Even though certain embodiments of invention have been illustrated and described, it should be emphasized that are numerous modifications thereon such as the process conditions, changes in formulation, among others.

Therefore, it will be apparent for any person skilled in the art that the embodiments of the procedure of the present invention and the product obtained thereof, are only illustrative but not limitative of the present invention, as several significant changes may be possible in its details but without being apart from the scope of the invention.

Therefore, the present invention shall not be considered restrictively except for the provisions in the state of the art, as well as by the scope of the attached claims.

### REFERENCES

Albdalá-Hurtado, Veciana-Nogués, lzquierdo-Pulido, Mariné-Font (1997). Determination of water-soluble vitamins in infant milk by high-performance liquid chromatography. Journal of chromatography de 778: 247-253.
Barquera S, Campos-Nonato, Hernández-Barrera, Pedroza-Tobias, Rivera-Dommarco (2013). Prevalence of obesity in Mexican adults, ENSANUT 2012. Salud Publica Mex.
Beristain-Bauza S C, Palou E, López-Malo A (2012). Bacteriocinas: antimicrobianos naturales y su aplicación en los alimentos. Temas Selectos de Ingeniería de Alimentos
Boskou D (2015). Olive oil: Properties and processing for use in food. Specialty Oils and Fats in Food and Nutrition. 3-38.
Burcelin R (2016). Gut microbiota and immune crosstalk in metabolic disease. Molecular metabolism. 5(9):771-781.
Burcelin R, Serino M, Chabo C, Blasco-Baque V, Amar J (2011). Gut microbiota and diabetes: from pathogenesis to therapeutic perspective. Acta Diabetol. 48:257-273.
De Angelis M, Di Cagno R, Huet C, Crecchio C, Fox P. F, Gobbetti M (2004). Heat shock response in Lactobacillus plantarum. In press Applied and Environmental Microbiology.
Especificaciones Sanitarias. Información Comercial. Métodos de prueba. (http://www.salud.gob.mx/unidades/cdi/nom/187ssa1scfi02.html).
Gámez H, Jarrin V, Parreño J (2015). Crecimiento L. plantarum y efecto sobre E. coli, S. typhimurium, C. perfringens, y S. aureus. Biotecnología en el Sector Agropecuario y Agroindustrial. 13(2):57-66.
Gazzali AM, Lobry M, Colombeau L, Acherar S, Azaïs H, Mordon S, Arnoux P, Baros F, Vanderesse R, Frochot C (2016). Stability of folic acid under several parameters. European Journal of Pharmaceutical Sciences. 93:419-430.
Gerald W., Tannock (2005). Probiotics And Prebiotics: Scientific Aspects, Horizon Scientific Press, 2005, p. 43.
Gobbetti M, Angelis De, Corsetti A, Cagno Di R (2005), Biochemistry and physiology of sourdough lactic acid bacteria. Trends in Food Science & Technology. 16:57-59.
Hernández A, Gutiérrez J P, Reynoso-Noverón (2013). Diabetes mellitus en México. El estado de la epidemia. Salud Pública de México. 55(2): S129-S136.
Illanes A (2015). Alimentos funcionales y biotecnologia. Revista Colombiana de Biotecnologia. XVII(1): 5-8.
Instituto Nacional de Salud Pública (2012). Encuesta Nacional de Salud y Nutrición 2012. Estado de nutrición, anemia, seguridad alimentaria en la población mexicana From hhttp://ensanut.insp.mx/doctos/ ENSANUT2012_Nutricion.pdf).
Nicolucci A C, Reimer R A (2016) Prebiotics as a modulator of gut microbiota in paediatric obesity._Pediatr Obes. doi: 10.1111/ijpo.12140.
Mexican Official Standard NOM-187-SSA1/SCF1-2002, Productos y servicios. Masa, tortillas, tostadas y harinas preparadas para su elaboración y establecimientos donde se procesan. Especificaciones sanitarias. Información comercial. Métodos de prueba.
Noskowa, G L (1972). Microbiología de las carnes conservadas por el frío. Editorial Acribia. Zaragoza. España.
Ranadheera C S, Liyanaarachchi W S, ChandrapalaJ, Dissanayake M, Vasiljevic C S (2016). Utilizing unique properties of caseins and the casein micelle for delivery of sensitive food ingredients and bioactives. In Food Science & Technology. 57:178-187.
Surco J C, Alvarado J A (2011). Estudio estadístico de pruebas sensoriales de harinas compuestas para panificación. Revista Boliviana de Química.28(2): 70-87.
Vartanian L R, Schwartz M B, Kelly D, Brownell K D (2007). Effects of Soft Drink Consumption on Nutrition and Health: A Systematic Review and Meta-Analysis. American Journal Public Health. 97(4): 667-675.
Yang N, Luan J, Ashton J, Gorczyca E, Kasapis S (2014). Effect of calcium chloride on the structure and in vitro hydrolysis of heat induced whey protein and wheat starch composite gels. Food Hydrocolloids. 42:260-268.

What is claimed is:

1. A process of preparation of a nutraceutical tortilla prepared from wheat flour, comprising steps of:
a) inoculating pasteurized milk with a lactic culture for 10 to 14 hours at 45±0.5° C.;
b) activating yeast by solubilizing in pasteurized milk and incubating at 20±0.5° C. for 10 to 15 hours;
c) mixing the inoculated pasteurized milk of step a) with the pasteurized milk having activated yeast of step b);
d) mixing all dry ingredients of the formulation including: from 50 to 55% by weight of wheat flour; from 3.5 to 5.5% by weight of Inulin; from 3.0 to 3.5% of Whey solids (SSL); from 0.5 to 0.7% of Calcium chloride (CaCl₂); from 0.003 to 0.005% of folic acid; from 2.0 to 3.0% of sucrose; and from 0.5 to 0.7% of Sodium chloride (NaCl);
e) adding olive oil followed by milk obtained in step c);
f) kneading until forming a lump-free dough;
g) forming dough balls of 30±0.5 g weight;
h) resting the dough balls at a temperature of 20 to 25° C. for 3.0 to 4.0 hours to ferment the yeast in the dough balls;
i) after fermentation, pressing the dough balls until forming a tortilla of 14-15 cm diameter;
j) cooking the tortilla at a temperature from 60 to 65° C., during 15 to 20 seconds on each side adding flour to prevent burning; and
k) packaging the cooked tortilla in a tight closure bag, and removing all the air to form a vacuum.

2. The process for preparation of a nutraceutical tortilla prepared from wheat flour according to claim 1, wherein the process includes two fermentation processes comprising an alcoholic fermentation produced by yeast and a lactic fermentation produced by lactic bacteria.

3. The process for preparation of a nutraceutical tortilla prepared from wheat flour according to claim 2, wherein organic acids such as lactic acid and bacteriocins are produced during fermentations therefore the addition of preservatives is not required.

4. The process for preparation of a nutraceutical tortilla prepared from wheat flour according to claim 1, wherein step a) is carried out under anaerobic conditions.

5. The process for preparation of a nutraceutical tortilla prepared from wheat flour according to claim 1, wherein the lactic culture of step a) is a lactic bacteria comprising at least one of Streptococcus thermophilus, Lactobacillus bulgaricus, and/or Lactobacillus plantarum.

6. The process for preparation of a nutraceutical tortilla prepared from wheat flour according to claim 1, wherein step b) comprises activating yeast in an alcoholic fermentation and the yeast is Saccharomyces cerevisiae.

7. The process for preparation of a nutraceutical tortilla prepared from wheat flour according to claim 6, wherein during the alcoholic fermentation of step b), Saccharomyces cerevisae hydrolyzes starches from wheat flour into glucose molecules that are then transformed into ethanol and carbon dioxide (CO₂), resulting in foamy, soft and elastic dough, product of binding wheat proteins, gliadin and glutenin.

8. The process for preparation of a nutraceutical tortilla prepared from wheat flour according to claim 7, wherein wheat proteins, gliadin and glutenin, form a three dimensional network favored by a pH decrease produced by pyruvic and lactic organic acids during lactic fermentation.

9. The process for preparation of a nutraceutical tortilla prepared from wheat flour according to claim 7, wherein CO₂ that is trapped in the dough favors the growth of lactic bacteria generating optimal anaerobiosis conditions and a microaerophilic environment allowing for probiotic microorganism viability, growth and reproduction.

10. The process for preparation of a nutraceutical tortilla prepared from wheat flour according to claim 1, wherein, due to temperature conditions of step j), lactic bacteria maintain viability and a probiotic property of 1×10⁶ UFC/mL.

11. The process for preparation of a nutraceutical tortilla prepared from wheat flour according to claim 1, wherein the inulin is blue agave heart derived from Tequilana weber.

12. A nutraceutical tortilla prepared from wheat flour obtained with the process in claim 1, wherein the tortilla comprises from 50 to 55% Wheat flour; from 32 to 36% Cow milk fermented with lactic culture; from 3.5 to 5.5% Inulin; from 3.0 to 3.5% Whey solids (SSL); from

0. 5 to 0.7% Calcium chloride (CaCl₂) ; from 0.003 to 0.005% Folic acid; from 2.8 to 3.5% Olive oil; from 2.0 to 3.0% Sucrose; and from 0.5 to 0.7% Sodium chloride.

13. The nutraceutical tortilla prepared from wheat flour according to claim 12, wherein the tortilla has a shelf life of up to 40 days at room temperature and up to three months under refrigeration.

14. The nutraceutical tortilla prepared from wheat flour according to claim 12, wherein the cow milk fermented with lactic culture includes two fermentation processes including an alcoholic fermentation produced by yeast and a lactic fermentation produced by lactic bacteria.

15. The nutraceutical tortilla prepared from wheat flour according to claim 12, wherein the inulin is blue agave heart derived from Tequilana weber.
